(19) United States
(12) Patent Application Publication
(10) Pub. No.: US 2022/0171861 A1
(43) Pub. Date: Jun. 2, 2022

(54) Dynamic Risk-Aware Patch Scheduling

(71) Applicant: BOARD OF TRUSTEES OF THE UNIVERSITY OF ARKANSAS, Fayetteville, AR (US)

(72) Inventors: Qinghua Li, Fayetteville, AR (US); Fengli Zhang, Fayetteville, AR (US)

(73) Assignee: BOARD OF TRUSTEES OF THE UNIVERSITY OF ARKANSAS, Fayetteville, AR (US)

(21) Appl. No.: 17/539,937

(22) Filed: Dec. 1, 2021

Related U.S. Application Data
(60) Provisional application No. 63/119,982, filed on Dec. 1, 2020.

(51) Int. Cl. G06F 21/57; G06F 8/65

(52) U.S. Cl. CPC G06F 21/577; G06F 8/65

(57) ABSTRACT

A program that defines and assesses the dynamic risk of software vulnerabilities and considers the dynamic risks into patch scheduling to reduce security risks posed by vulnerabilities and provide formal guidance to security operations at various organizations.

### RELATED APPLICATIONS

This application claims priority to U.S. Provisional Application No. 63/119982 filed Dec. 1, 2020, which is incorporated herein in its entirety

### STATEMENT REGARDING FEDERALLY SPONSORED RESEARCH & DEVELOPMENT

This invention was made with government support by the NSF award 1751255 and the DOE award DE-0E0000779. The government has certain rights in the invention.

### INCORPORATION BY REFERENCE OF MATERIAL SUBMITTED ON A COMPACT DISC

Not applicable.

### BACKGROUND OF THE INVENTION

Security vulnerabilities in software pose significant security risks to information systems since they can be exploited by attackers to breach into systems. Unfortunately, vulnerabilities are unavoidable and could affect all installed software tools. Every month, many new vulnerabilities are discovered and released, which need to be patched and mitigated timely to reduce the security risks that they pose to a system. For many organizations, however, not all vulnerabilities can be patched quickly due to limited resources and security personnel in their organizations. Properly scheduling the vulnerability patching order under available resources can significantly reduce the overall security risks that a system faces.

In practice, many organizations determine the patching order for vulnerabilities based on security operators' subjective assessment and/or preference. That could result in random, ad hoc patching orders. Others schedule patches based on the prioritization order provided by some patch management software, where the patches are usually prioritized by vulnerabilities' risks measured by Common Vulnerability Scoring System (CVSS) scores [1]. CVSS score shows the severity of software vulnerabilities which is assessed and maintained by the National Vulnerability Database (NVD) [2]. However, existing metrics for prioritizing patches have two weaknesses. First, they are static and hence cannot capture the time-dependent nature of risks as elaborated below. Second, they do not consider the time cost of applying patches. Thus, although they could be used for prioritizing patches and generating a simple patch schedule, the ignorance of patching cost could lead to suboptimal decisions especially for small-sized and medium-sized organizations with limited security resources.

The risk of a vulnerability depends on two factors, the likelihood of exploitation and the impact of exploitation. The likelihood of exploitation is dynamic in nature and changes with time. For example, the chance that a vulnerability is exploited one day after it is released might be low but the chance that it is exploited one year after release is much higher since attackers have much more time to develop exploits for it. The difficulty of developing exploit for a vulnerability depends on the nature of the software (e.g., Windows or Linux software), the nature of the vulnerability (e.g., buffer overflow or protocol design flaws), whether exploits have been developed before for similar vulnerabilities, and how much value the software/vulnerability has to the adversary. They all affect how long it will take the adversary to develop exploits for vulnerabilities.

Neglecting such dynamic natures in scheduling will cause ineffective risk mitigation. For a simple example, suppose two vulnerabilities Va and Vb are published at the same time, have the same overall risk score (e.g., CVSS score) which is static and does not depend on time, and each takes one day to patch. Va is highly likely to be exploited in day 1 after public release. Vb has a very low likelihood to be exploited in the first two days after release but is more likely to be exploited after day 2. If patch scheduling only considers the overall risk score, either of them can be patched first. However, in this example, patching Va first and Vb next will have lower security risks.

For the two factors of risk, although the impact score of published vulnerabilities is usually available (e.g., the CVSS impact score) as a good estimate of their impact, their likelihood of exploitation is usually unknown, not to mention the dynamic likelihood over time. Thus, currently there are two technical gaps: i) deriving vulnerabilities' dynamic likelihood of exploitation and dynamic risk, and ii) utilizing the dynamic risk information in patch scheduling.

### BRIEF SUMMARY OF THE INVENTION

In one embodiment, the present invention has three components. The first component is the definition of a new risk metric based on the dynamic probability of exploit. A vulnerability's probability of exploit at time T is defined as the probability that known exploit code for the vulnerability is available by time T after the vulnerability is released at time 0. (It is possible that an adversary has developed exploit code for a vulnerability but does not publish it. However, for this embodiment, the present invention only considers known exploits to make the problem tractable.) The second component is a novel method to predict vulnerabilities' dynamic probability of exploit over time. The method is constructed based on machine learning. The third component consists of two dynamic risk-aware patch scheduling algorithms, baseline scheduling and group-based scheduling, to minimize the total security risks posed by vulnerabilities. The baseline scheduling method has optimal risk reduction but high computation overhead. The group-based scheduling method has much lower computation cost but still effective risk reduction.

In other aspects, the present invention considers the dynamic risks of vulnerabilities into patch scheduling. It can reduce security risks posed by vulnerabilities and provide formal guidance to security operations at various organizations.

In another embodiment, the present invention provides a method that defines and assesses the dynamic risk of software vulnerabilities and considers the dynamic risks into patch scheduling to reduce security risks posed by vulnerabilities and provide formal guidance to security operations at various organizations.

In another embodiment of the present invention, dynamic risk metric is defined for assessing the security risks of software vulnerabilities, comprising the steps of;

using a function r(t) to denote the risk that a vulnerability has posed to the system by time point t, assuming the vulnerability is published at time 0;

using a function p(T) to denote a vulnerability's probability of exploit at time T;

using I to denote a vulnerability's impact score on the system; and

the function r(t)is defined as the integral of I*p(T) in the interval [0, t].

In another embodiment of the present invention, the function p(T) is predicted by identifying a set of vulnerability features.

In another embodiment, the present invention, comprises the step of considering a certain vulnerability management cycle of n days, wherein one model is trained for each day to predict the probability of exploit by that day. Also, to train the model for the i^{th} day, the training dataset is relabeled based on whether each vulnerability has exploit code by the i^{th} day or not.

In another embodiment of the present invention, to predict for a new vulnerability, the new vulnerability's corresponding features are fed into all the models which will output the exploit probability by each day.

In another embodiment, the present invention comprises the step of formulating the baseline scheduling problem where for all the vulnerabilities being considered at the current scheduling cycle, the optimization goal is to minimize the total dynamic risk of the vulnerabilities, where the total risk is defined as the sum of all the vulnerabilities' dynamic risk and each vulnerability's dynamic risk depends on when the vulnerability is scheduled to be patched, under four conditions—each vulnerability needs a certain amount of time to patch, each vulnerability is assigned once to exactly one security operator, one security operator can only patch one vulnerability at a time, and if a patch i depends on another patch j, it cannot be installed until patch j is installed.

In another embodiment, the present invention comprises the step of formulating a group-based scheduling problem, where software assets are divided into g groups based on their functions and other relevant factors. Then the scheduling problem is solved in two phases.

In the first phase (group-level scheduling), the vulnerabilities in each software group are considered as one aggregate vulnerability to determine the order of groups to be patched. Specifically, the aggregate vulnerability's dynamic risk is defined as the sum of the dynamic risk of all vulnerabilities in the group evaluated at the time this aggregate vulnerability is scheduled to be patched; the aggregate vulnerability's time cost of patching is defined as the sum of the patching time cost of all vulnerabilities in the group. Then the g aggregate vulnerabilities corresponding to the g groups are scheduled following the baseline scheduling formulation described above. That determines the order of the groups to be patched.

In the second phase (intra-group scheduling), each group is considered separately and the vulnerabilities in each group are scheduled according to the baseline scheduling formulation described above.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 illustrates function p(T) plotted as a curve for an example using the embodiments of the present invention.

FIG. 2 illustrates function p(T) plotted as a curve for another example using the embodiments of the present invention.

FIG. 3 shows the baseline scheduling problem formulation used with various embodiments of the present invention.

FIG. 4 shows a group-level scheduling problem formulation used with embodiments of the present invention.

FIG. 5 shows an intra-group scheduling problem formulation.

FIG. 6 shows prediction accuracy for an embodiment of the present invention.

FIG. 7 depicts the total amount of risks of unpatched vulnerabilities under one operator for 120 vulnerabilities.

FIG. 8 depicts the total amount of risks of unpatched vulnerabilities under one operator for 390 vulnerabilities.

FIG. 9 depicts number of vulnerabilities patched before exploit appears under one operator.

FIG. 10 depicts recovery delay under one operator.

FIG. 11 depicts total amount of risks of unpatched vulnerabilities under multiple operators.

FIG. 12 depicts number of vulnerabilities patched before exploit appears under multiple operators.

FIGS. 13 depicts recovery delay under multiple operators.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure, or system. Further, the terms and phrases used herein are not intended to be limiting, but rather to provide an understandable description of the invention.

### Dynamic Risk Metric

The present invention defines a new metric to quantify the dynamic risk that a vulnerability poses to the system by considering its dynamic probability of exploit and its impact on the system. Let function r(t) denote the risk that the vulnerability has posed to the system by time point t (assuming the vulnerability is published at time 0), function p(T) denotes the vulnerability's probability of exploit at time T, and I is the vulnerability's impact score on the system. Then the risk function r(t) is defined as the integral of I*p(T) in the interval [0, t]. For impact score, it could follow the calculation of the standard CVSS scoring system [3] which makes it a constant irrelevant to time. It could also use other impact scores derived by relevant software tools and third-party services.

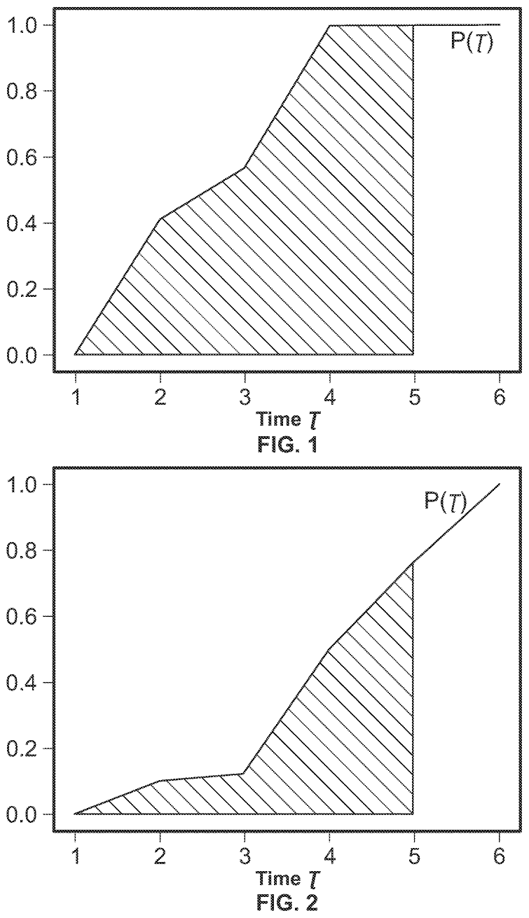

This risk definition involves two factors. The first factor is impact score, which is easy to understand. The second factor is the integral of function p(T) in the interval [0, t]. If the function p(T) is plotted as a curve (see FIG. 1 and FIG. 2 for examples), this factor is essentially the size of the grey area under the curve. It in turn considers two factors, the probability that exploit code is available and the time duration of exploit code being available. It makes sense since the more quickly a vulnerability's probability of exploit increases and the longer time a vulnerability is exposed (i.e., stays unpatched) the higher risk it could pose to the system. For the examples in FIG. 1 and FIG. 2, vulnerability Va has higher risk than Vb when considering the exposure time up to day 5.

### Predicting the Probability of Exploit

At the high level, the method uses data-driven prediction based on a vulnerability dataset. First, a set of vulnerability features is identified. Then a set of predictive machine learning models is trained. In particular, considering a certain vulnerability management cycle of n days (typically 30 days which means monthly vulnerability assessment and mitigation), one model is trained for each day to predict the probability of exploit by that day (the first day, the second day, etc.). To train the model for the i^{th} day, the training dataset is relabeled based on whether each vulnerability has exploit code by the i^{th} day or not. To predict for a new vulnerability, the vulnerability's corresponding features are fed into all the models which will output the exploit probability by each day.

Vulnerability dataset. For an embodiment, the present invention collected all the vulnerabilities in the Vulners database in June 2019, which consist of 67,965 vulnerabilities. 46,380 of them have no known exploits, 17,260 already have exploits before vulnerabilities are published, and for the other 4,325 vulnerabilities their exploits are released after they are published. The 4,325 vulnerabilities whose exploits appear after they are published was used as the dataset for training the prediction model. To keep the dataset's balance, the present invention randomly sampled 4,325 out of the 46,380 vulnerabilities that do not have known exploits and add them to the dataset as well. This aggregate dataset will be used as training data to train neural network models. Note that although the Vulners database is used to instantiate the invention, the invented approach is general and can work with other databases as well such as the National Vulnerability Database.

Feature selection. To train the neural network model, the important features to represent each vulnerability need to be selected. Since CVSS is used to describe the primary characteristic of vulnerabilities, CVSS metrics are used as part of the features which include: attack vector (how the vulnerability is exploited, e.g. through network or local access), attack complexity, user interaction (whether user interaction is needed to exploit the vulnerability), privilege (the privilege level required to exploit vulnerability), confidentiality impact (the impact on the system's confidentiality if the vulnerability is exploited), integrity impact (the impact on the system's integrity if the vulnerability is exploited), availability impact (the impact on the system's availability if the vulnerability is exploited), and CVSS score (the vulnerability's overall severity level). Common weakness enumeration (CWE) [4] which depicts the vulnerability type, and software name are also used as two features. Besides, each vulnerability has its description and title which also provide valuable information. Since descriptions and titles are descriptive texts, we apply tf-idf (term frequency-inverse document frequency) [5] to extract important words from description and title texts as features. Tf-idf is able to identify important words and deprive the words that do not carry useful information such as “the” and the common words that appear in most descriptions and titles such as “CVE”. The present invention uses tf-idf to extract bi-grams (two adjacent words) as features, which was found to have better performances than uni-gram (single word) in this prediction task. The top 3,000 most important bi-grams such as “windows server”, “execute arbitrary”, “verify certificates”, “spoof servers”, “access restriction” from descriptions and the top 500 most important bi-grams from titles are extracted as features used in prediction. In addition, each vulnerability has a publish date, modify date and last seen date. Publish date is the day when the vulnerability is published; modify date is the day when the vulnerability is modified such as the modification of its title or description; and last seen date is the last date when the vulnerability was seen. If a vulnerability is modified or is still seen long after being published, it shows that this vulnerability still persists and attracts people's attention. Such vulnerabilities may carry high risk and are more likely to be attackers' targets. Therefore, the time difference between modify date and publish date and the time difference between last seen date and publish date was used as features. In total, each vulnerability record has 3,512 features.

Prediction. The present invention builds neural network models to predict the probability of exploit. The collected vulnerability dataset described above can be used to train the neural network models. The present invention predicts the probability of exploit for vulnerabilities by each day. To do this, the present invention builds one neural network model for each day. When building the model for predicting the probability of exploit by day n after vulnerability release, the present invention generates the training data for this model by relabeling the vulnerability dataset. If a vulnerability's exploit code becomes available within n or less days, it is labeled as 1; otherwise, it is labeled as 0. Then this relabeled dataset is used to train the neural network model and this model will be used to predict the probability of exploit for day n. If vulnerability patch scheduling is done monthly (as many organizations do), we need to predict the exploit probability and build one model for each day in the following month. Therefore, about 30 neural network models need to be built in each scheduling cycle. Then to predict for a new vulnerability, the vulnerability's corresponding features can be fed into the 30 trained neural models which will output the exploit probability by each day of the 30 days.

### Patch Scheduling Algorithms

A vulnerability's probability of exploit is changing over time and so is the risk that the vulnerability poses to the system. It is important to carefully schedule the patching order of vulnerabilities so that the system's total security risk is as low as possible. The present invention takes an example to show how the patching order affects the total risk. Suppose that a system has two vulnerabilities to patch, Va and Vb. Va's impact score is 8.0, Vb's impact score is 7.0 and they are published at the same time. Va's probability of exploit is 0.6 by the first day, 0.65 by the second day, and 0.7 by the third day. Vb's probability of exploit is 0.6 by the first day, 0.8 by the second day, and 0.9 by the third day. It takes about 2 days to patch Va and 1 day to patch Vb. If the patches are prioritized only by impact score, Va will be patched first. Then the risk from Va is 8.0*0.6*1+8.0*0.65*1=10.0, the risk from Vb is 7.0*0.6*1+7.0*0.8*1+7.0*0.9*1=16.1, and the total risk is 26.1. If Vb is patched first, the risk from Va is 8.0*0.6*1+8.0*0.65*1+8.0*0.7*1=15.6, the risk from Vb is 7.0*0.6*1, and the total risk is 19.8. From the example, it can be seen that different patching orders can significantly affect the total risk, and considering dynamic risks matters.

### Baseline Scheduling

Let v_i (here “_i” means i is subscript) denote vulnerability i, p_i(T) denote the exploit probability of vulnerability v_i at time T, I_i denote the impact score of v_i, s_i denote starting time of patching vulnerability v_i, and d_i denote the time needed to process/install patch for vulnerability v_i. The objective is to schedule the patch order so that the total risk that the vulnerabilities pose to the system is minimized. The risk of an unpatched vulnerability at time t is r(t) which is defined above.

### New Risk Metric

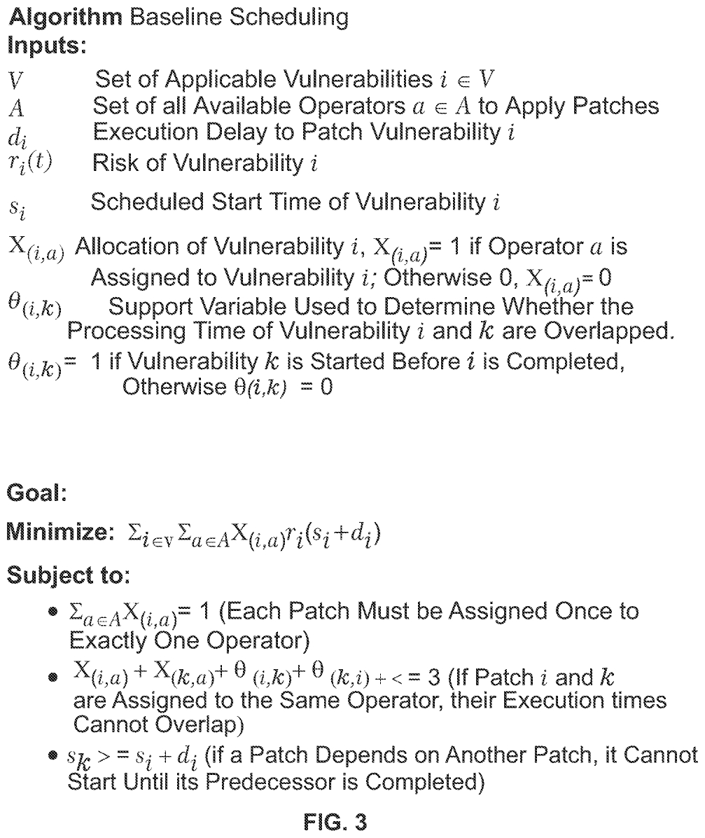

Since a vulnerability cannot be exploited after it is patched, this vulnerability will not pose any risk to the system after being patched. Thus the total risk caused by vulnerability v_i is r_i(s_i+d_i), which can be expressed by I_i multiplied by the integral of function p_i(T) in the interval [0, s_i+d_i]. Note that time 0 is considered as the time when vulnerability v_i is released. For ease of calculation, this formula can be converted to discrete form using one time unit as the step size: r_i(s_i+d_i)=I_i*((p_i(0)+p_i(1))/2+(p_i(1)+p_i(2))/2+(p_i(2)+p_i(3))/2+ . . . +(p_i(s_i+d_i−1)+p_i(s_i+d_i))/2). The length of time unit can be flexibly set based on application scenarios. If the time unit is set as 30 minutes, then s_i=10 means the patching starts at time unit 10 and d_i=2 means it takes 2 time units to complete patching. For all the vulnerabilities being considered at the current scheduling cycle, the total risk is simply the sum of all the vulnerabilities' risks. The goal of scheduling is to minimize the total risk that the unpatched vulnerabilities pose to the system. The full problem formulation is given in FIG. 3.

This formulated scheduling model is a NP-hard problem. It can be solved using some existing tools such as the OR-Tools library [6]. Note that our invention is the scheduling model but not the solver.

### Group-Based Scheduling

The baseline scheduling model can give an optimal patching order for all the vulnerabilities, but since it is NP-hard, it takes too long time to get the optimized schedule when there are many vulnerabilities. Experiments show that when there are 200 vulnerabilities, it will take more than 2 days to solve it which is not practical. However, in practice it is not uncommon for an organization to have several hundred vulnerabilities to patch in each month. Thus, a computationally more efficient solution is needed. To address this need, the present invention uses a group-based scheduling method which can greatly reduce the computation overhead while still providing good effectiveness in risk reduction.

The basic idea is to divide software into groups based on their functions and other relevant factors. Then the scheduling problem can be solved into two phases. In the first phase (group-level scheduling), the vulnerabilities in each software group are considered as one vulnerability to determine the order of groups to be patched. In the second phase (intra-group scheduling), the present invention considers each group separately and schedules the vulnerabilities in each group to determine their order of patching. The computation cost of the first phase depends on the number of groups, and the computation cost of the second phase depends on the number of vulnerabilities in each group. Since both numbers are much smaller than the total number of vulnerabilities (i.e., the problem size in the baseline scheduling), this group-based solution should have much lower computation cost.

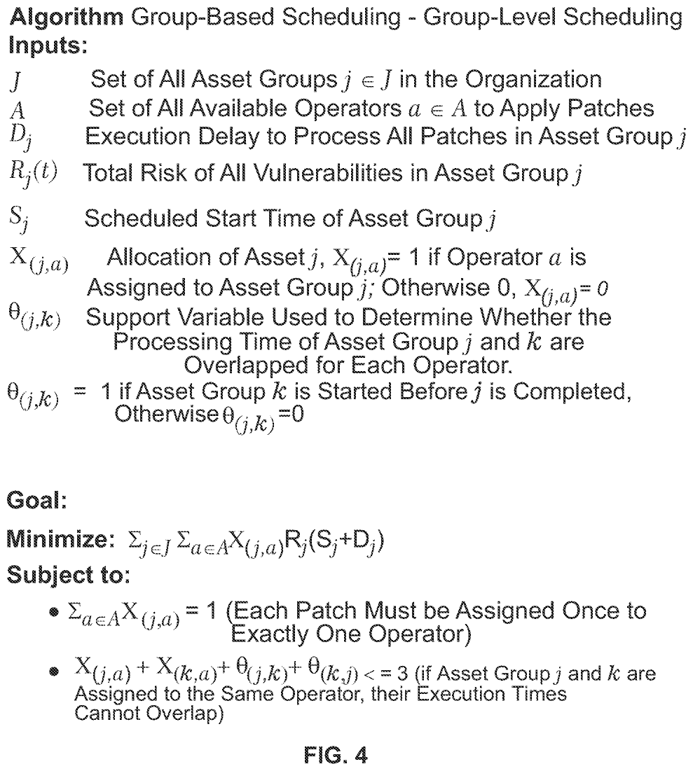

Phase I—Group-Level Scheduling: In this phase, each software group is taken as one task. Let R_j(t) to denote the risk of all vulnerabilities in software group j over time t. It is defined as the sum of risks of all the vulnerabilities in this group. Let D_j denote the time needed to patch all vulnerabilities in group j. It is defined as the sum of the patching time cost of all the vulnerabilities in this group. In an organization, there might be multiple operators applying patches. One operator can be responsible for one or several asset groups, but when one asset group is assigned to an operator, the operator will be responsible for all the vulnerabilities in that asset group. With these considerations, the group-level scheduling problem is formulated in FIG. 4.

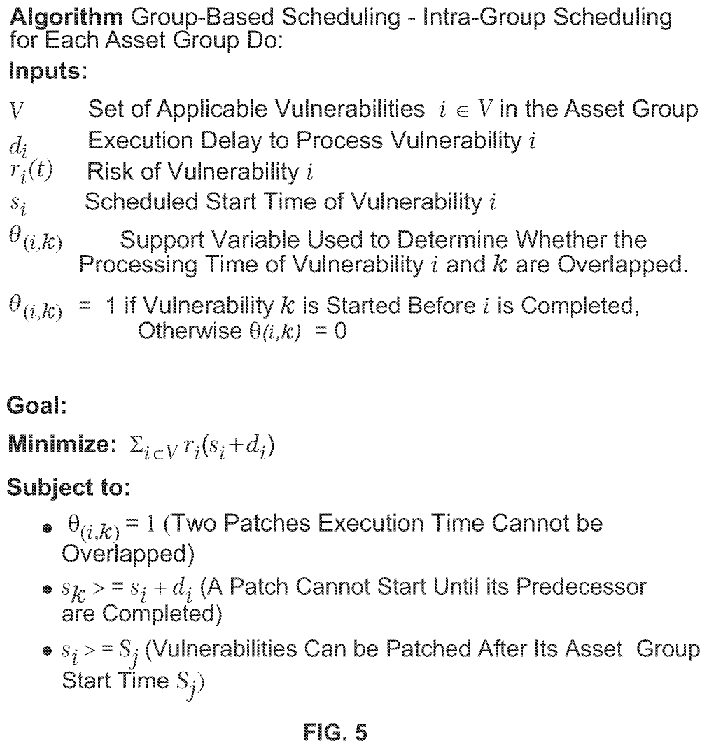

Phase II—Intra-Group Scheduling: After getting the software group patching order, there is a need to schedule the patching order for the vulnerabilities in each group. The present invention can get each software group's patch start time S_j from the Phase I scheduling. Then the vulnerabilities in this group should be patched starting from S_j. The intra-group scheduling problem is formulated in FIG. 5.

This group-based scheduling model is also NP-hard. It can be solved using existing tools such as the OR-Tools library [6].

[3] Impact score. Available: https://www.first.org/cvss/v2/guide
[4] Common weakness enumeration (cwe).
https://nvd.nist.gov/vuln/categories
[5] Tf-idf. http://www.tfidf.com/
[6] Or-tools. https://developers.google.com/optimization

### Prediction on Probability of Exploit

The dataset used in this exploitability prediction experiment consists of 8,650 vulnerabilities, half of which have exploit and half do not have exploit as described above. In evaluations, the present invention splits the dataset into two parts: 67% as the training data and the remaining 33% as testing data. The neural network prediction models were implemented with Python. Each model has two hidden layers with 100 and 30 neurons respectively. The output layer outputs the probability of exploit.

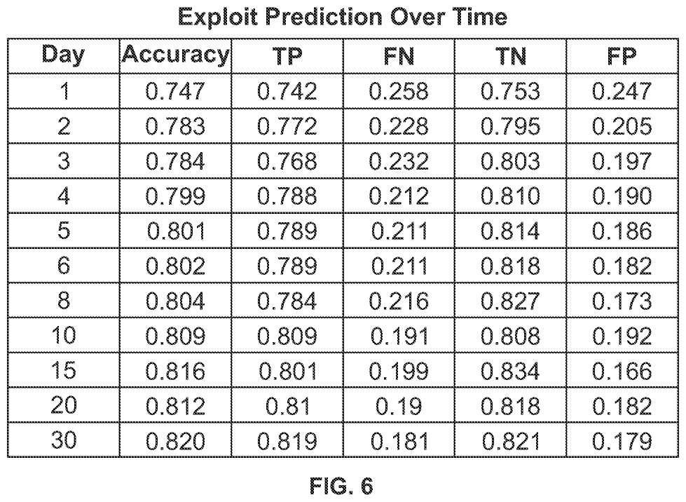

The exploit predictions may be evaluated over time. For each day's exploit prediction, there is one neural network model trained and tested specially for that day. One study predicted the exploit probability for 30 days, and thus there is 30 neural network models. The models were run on a laptop computer with 1.60 GHz CPU and 16.0 GB memory. It takes a total of 63.5 minutes to train all the 30 models. These models are trained once a month and can be trained in advance. Thus, the training of the models will not delay any patching. The prediction for each vulnerability is super quick and it only takes 1.34 milliseconds. The prediction accuracy is shown in FIG. 6. Here prediction accuracy is defined as the portion of correct predictions out of all predictions, true positive (TP) is defined as the portion of vulnerabilities that have exploit and are predicted to have exploit, true negative (TN) is defined as the portion of vulnerabilities that do not have exploit and are predicted to not have exploit, false negative (FN) is defined as the portion of vulnerabilities that have exploit but predicted to not have exploit, and false positive (FP) is defined as the portion of vulnerabilities that do not have exploit but are predicted to have exploit. The accuracy is pretty high. As the time goes by, the prediction accuracy becomes higher and higher. For example, the prediction accuracy for Day 1 is 74.7\%, and the prediction accuracy for Day 30 is 82.0\%. This is because as the time goes by, more vulnerabilities have exploits and the dataset is more balanced between vulnerabilities with exploit and vulnerabilities without it.

### Evaluation of Patch Scheduling

One evaluation used real software data from one company to extract 390 applicable vulnerabilities published in January 2019 from the Vulners database. Based on the company's input on the time range of patching a vulnerability, the patching time cost for each vulnerability was randomly generated within the range from 0.5 hours to 4 hours. There are 26 asset groups. The exploit probability for each retrieved vulnerability was predicted with neural network models. Then baseline scheduling and the group-based scheduling methods we run to get optimal patching orders. One organization usually has multiple security operators to apply patches.

The present invention was compared with three other patching methods commonly used in practice, patching randomly, CVSS-based patching, and time-based patching. In the random patching method, the operators patch vulnerabilities in random orders. In CVSS-based patching, the vulnerabilities with higher CVSS scores are patched first. In time-based patching, the vulnerabilities which are published earlier are patched first.

These methods are compared along three metrics. The first metric is the total amount of risks that unpatched vulnerabilities pose to the system. The second metric is the number of the vulnerabilities that are patched before exploits are available. If some vulnerabilities cannot be patched before exploits are available, hopefully they can be patched as soon as possible so that the system is exposed to the exploits for a shorter time. Thus, in the third metric, for those vulnerabilities which are not patched before exploits are available, the time difference between the patching time and the time of exploits being available were calculated to see how long the system is exposed to the exploitable vulnerabilities. The time difference is called recovery delay.

### Comparison between all methods

Since it takes too long time for the baseline scheduling method to get the optimized patching order for all the 390 vulnerabilities, 120 vulnerabilities were used for this comparison. In this comparison, only one operator is considered to perform the vulnerability patching operations. A comparison of how the methods perform on risk reduction is shown in FIG. 7.

The baseline scheduling method has the lowest security risk. The risk of group-based scheduling is higher than the baseline scheduling, which is not unexpected, but it is still much lower than the risks of the other three scheduling methods, which means group-based scheduling is still very effective in risk reduction. To better compare the baseline scheduling method and the group-based method, their running time was measured on a laptop computer with 1.60 GHZ CPU and 16.0 GB memory. The running time of the group-based model to get optimal schedule is 14 seconds, but that of the baseline model is 319 seconds which is much longer. When there are 200 vulnerabilities to patch, it only takes the group-based method 29 seconds to get the optimal schedule, but it would take more than 48 hours for the baseline model to get the optimal schedule (even running the method for 48 hours still did not get the optimal solution). It can be seen that the group-based method has much higher computation efficiency and can handle much larger problem sizes than the baseline method. Thus, the group-based scheduling method achieves good tradeoff between computation cost and effectiveness of risk reduction.

Comparison between group-based scheduling and other methods.

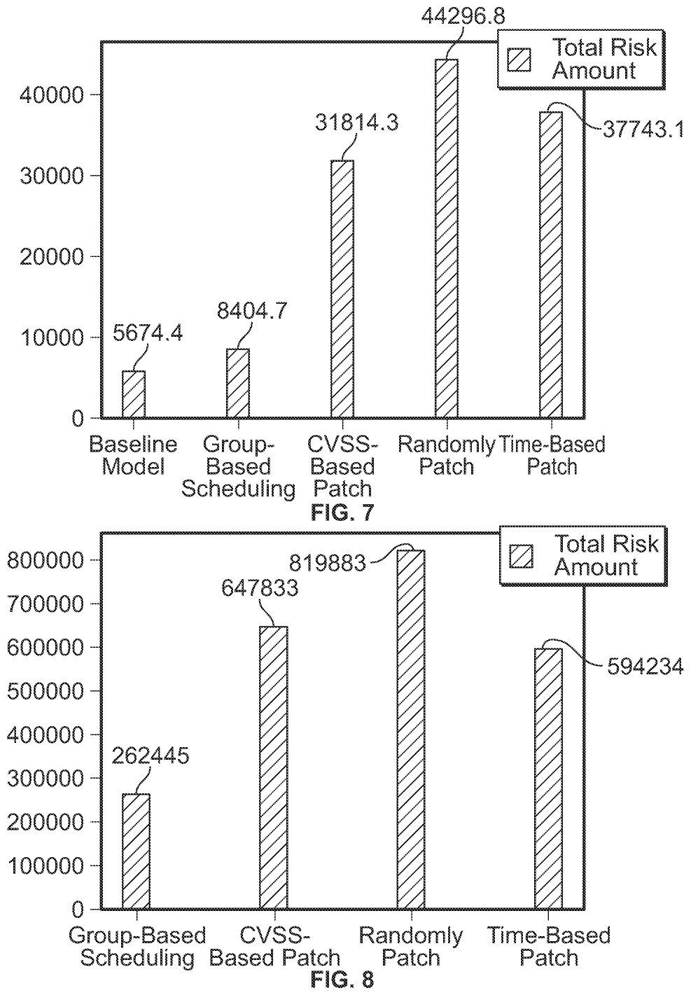

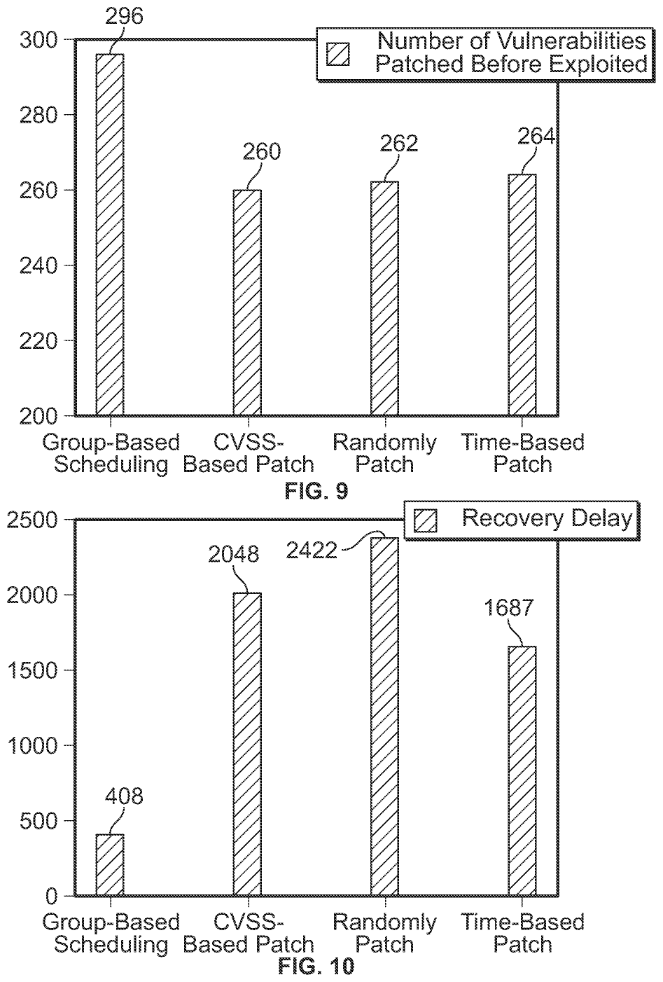

In the following, the group-based method was compared with random patching, CVSS-based patching and time-based patching using all the 390 vulnerabilities. FIG. 8-10 show the comparison results when there is only one operator. FIG. 8 shows that the total risk can be significantly reduced when scheduling patches using the embodiments of the present invention. The present invention reduces the total risk by about 70%, 60% and 56% respectively compared with randomly patching, CVSS-based patching and time-based patching. From FIG. 9, it can be seen that the present invention can patch most vulnerabilities before they have exploits. Out of those 94 vulnerabilities whose have exploits before they are patched, 49 of them already have exploits before they are published (i.e., zero-day vulnerabilities), which cannot be addressed by any scheduling algorithm. FIG. 10 shows that the present invention has the lowest recovery delay, which means the system is exposed to the exploitable vulnerabilities for the shortest time.

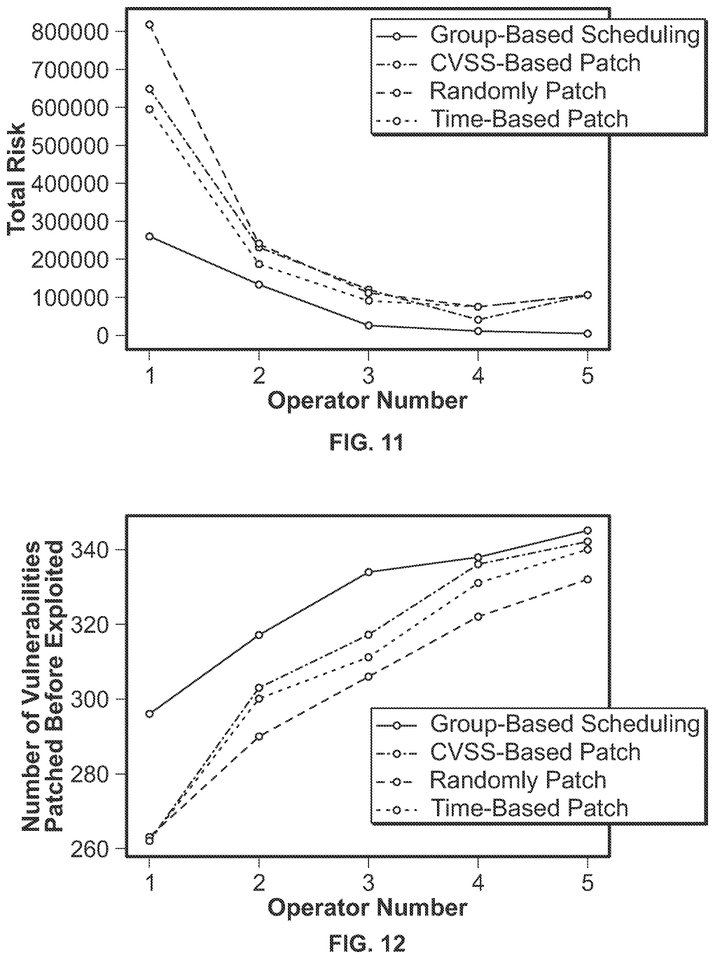

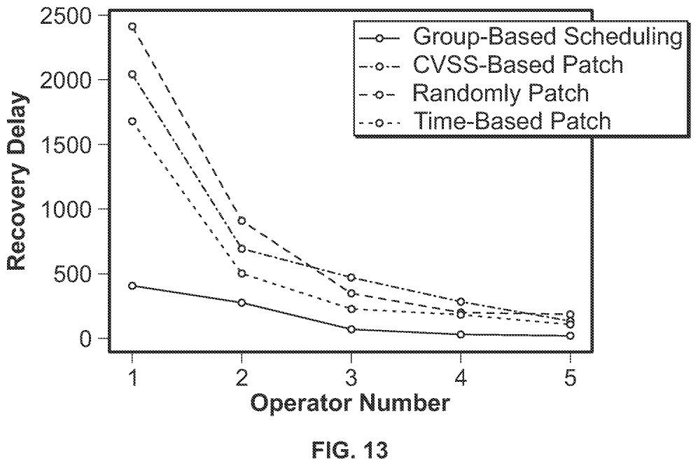

FIG. 11-13 show the comparisons when there are multiple operators. From these figures, it can be seen the group-based scheduling method has the lowest total risk, patches more vulnerabilities before they have exploits, and has the lowest recovery delay. When there are more operators, the differences between these methods become smaller. This is because when there are more operators, more vulnerabilities can be patched timely no matter which method is used. Thus, the present invention is especially useful for small-sized and medium-sized companies that have relatively limited security personnel compared with the amount of vulnerabilities they need to handle.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

Also, to the above description, the materials attached hereto form part of the disclosure of this provisional patent application.

What is claimed is:

1. A method that defines and assesses the dynamic risk of software vulnerabilities and considers the dynamic risks into patch scheduling to reduce security risks posed by vulnerabilities and provide formal guidance to security operations at various organizations.

2. The method of claim 1 wherein a dynamic risk metric is defined for assessing the security risks of software vulnerabilities, comprising the steps of;
using a function r(t) to denote the risk that a vulnerability has posed to the system by time point t, assuming the vulnerability is published at time 0;
using a function p(T) to denote a vulnerability's probability of exploit at time T;
using I to denote a vulnerability's impact score on the system; and
said function r(t)is defined as the integral of I*p(T) in the interval [0, t].

3. The method of claim 2 wherein said function p(T) is predicted by identifying a set of vulnerability features.

4. The method of claim 3 further comprising the step of training a set of predictive machine learning models using the identified vulnerability features.

5. The method of claim 4 further comprising the step of considering a certain vulnerability management cycle of n days, wherein one model is trained for each day to predict the probability of exploit by that day.

6. The method of claim 5 wherein to train the model for the i^{th} day, the training dataset is relabeled based on whether each vulnerability has exploit code by the i^{th} day or not

7. The method of claim 3 wherein to predict the dynamic risk for a new vulnerability, the new vulnerability's corresponding features are fed into all the models which will output the exploit probability by each day.

8. The method of claim 1 further comprising the formulation of the baseline scheduling problem where for all the vulnerabilities being considered at the current scheduling cycle, the optimization goal is to minimize the total dynamic risk of the vulnerabilities, where the total risk is defined as the sum of all the vulnerabilities' dynamic risk and each vulnerability's dynamic risk depends on when the vulnerability is scheduled to be patched, under four conditions—each vulnerability needs a certain amount of time to patch, each vulnerability is assigned once to exactly one security operator, one security operator can only patch one vulnerability at a time, and if a patch i depends on another patch j, it cannot be installed until patch j is installed.

9. The method of claim 1 further comprising the formulation of the group-based scheduling problem, where software assets are divided into g groups based on their functions and other relevant factors, then the scheduling problem is solved in two phases.
a. in the first phase (group-level scheduling), the vulnerabilities in each software group are considered as one aggregate
vulnerability to determine the order of groups to be patched, said aggregate vulnerability's dynamic risk is defined as the sum of the dynamic risk of all vulnerabilities in the group evaluated at the time this aggregate vulnerability is scheduled to be patched; the aggregate vulnerability's time cost of patching is defined as the sum of the patching time cost of all vulnerabilities in the group, then the g aggregate vulnerabilities corresponding to the g groups are scheduled following the baseline scheduling formulation that determines the order of the groups to be patched.
b. in the second phase (intra-group scheduling), each group is considered separately and the vulnerabilities in each group are scheduled according to said baseline scheduling formulation.

10. A method that defines and assesses the dynamic risk of software vulnerabilities and considers the dynamic risks into patch scheduling to reduce security risks posed by vulnerabilities and provide formal guidance to security operations at various organizations, comprising the steps of:
defining a dynamic risk metric for assessing the security risks of software vulnerabilities by 1) using a function r(t) to denote the risk that a vulnerability has posed to the system by time point t, assuming the vulnerability is published at time 0; 2) using a function p(T) to denote a vulnerability's probability of exploit at time T; 3) using I to denote a vulnerability's impact score on the system; and 4) a said function r(t) is defined as the integral of I*p(T) in the interval [0, t];
said function p(T) is predicted by identifying a set of vulnerability features.
training a set of predictive machine learning models;
considering a certain vulnerability management cycle of n days, wherein one model is trained for each day to predict the probability of exploit by that day; and
formulating a baseline scheduling problem where for all the vulnerabilities being considered at the current scheduling cycle, the optimization goal is to minimize the total dynamic risk of the vulnerabilities, where the total risk is defined as the sum of all the vulnerabilities' dynamic risk and each vulnerability's dynamic risk depends on when the vulnerability is scheduled to be patched, under four conditions—each vulnerability needs a certain amount of time to patch, each vulnerability is assigned once to exactly one security operator, one security operator can only patch one vulnerability at a time, and if a patch i depends on another patch j, it cannot be installed until patch j is installed.

11. The method of claim 10 wherein to train the model for the i^{th} day, the training dataset is relabeled based on whether each vulnerability has exploit code by the i^{th} day or not

12. The method of claim 10 wherein to predict for a new vulnerability, the new vulnerability's corresponding features are fed into all the models which will output the exploit probability by each day.

13. A method that defines and assesses the dynamic risk of software vulnerabilities and considers the dynamic risks into patch scheduling to reduce security risks posed by vulnerabilities and provide formal guidance to security operations at various organizations, comprising the steps of:
defining a dynamic risk metric for assessing the security risks of software vulnerabilities by 1) using a function r(t) to denote the risk that a vulnerability has posed to the system by time point t, assuming the vulnerability is published at time 0; 2) using a function p(T) to denote a vulnerability's probability of exploit at time T; 3) using I to denote a vulnerability's impact score on the system; and 4) a said function r(t) is defined as the integral of I*p(T) in the interval [0, t];
said function p(T) is predicted by identifying a set of vulnerability features.
training a set of predictive machine learning models;
considering a certain vulnerability management cycle of n days, wherein one model is trained for each day to predict the probability of exploit by that day; and
formulating a group-based scheduling problem, where software assets are divided into g groups based on their functions and other relevant factors, then the scheduling problem is solved in two phases.
a. in the first phase (group-level scheduling), the vulnerabilities in each software group are considered as one aggregate vulnerability to determine the order of groups to be patched. Specifically, the aggregate vulnerability's dynamic risk is defined as the sum of the dynamic risk of all vulnerabilities in the group evaluated at the time this aggregate vulnerability is scheduled to be patched; the aggregate vulnerability's time cost of patching is defined as the sum of the patching time cost of all vulnerabilities in the group, then the g aggregate vulnerabilities corresponding to the g groups are scheduled following the baseline scheduling formulation that determines the order of the groups to be patched.
b. in the second phase (intra-group scheduling), each group is considered separately and the vulnerabilities in each group are scheduled according to the baseline scheduling formulation.

14. The method of claim 13 wherein to train the model for the i^{th} day, the training dataset is relabeled based on whether each vulnerability has exploit code by the i^{th} day or not

15. The method of claim 13 wherein to predict for a new vulnerability, the new vulnerability's corresponding features are fed into all the models which will output the exploit probability by each day.
